(19) United States
(12) Patent Application Publication
(10) Pub. No.: US 2012/0262361 A1
(43) Pub. Date: Oct. 18, 2012

(54) Remote Monitoring and Control System, Approach, and Program

(75) Inventors: Katsuhide KITAGAWA, Hitachinaka (JP); Junichi Suzuki, Hitachiota (JP); Yoshio Maruyama, Mito (JP); Kazuo Furudate, Hitachi (JP); Hiroshi Suzuki, Mito (JP); Masafumi Ishii, Mito (JP)

(73) Assignee: Hitachi, Ltd., Tokyo (JP)

(21) Appl. No.: 13/445,521

(22) Filed: Apr. 12, 2012

(30) Foreign Application Priority Data
Apr. 15, 2011 (JP) 2011-091078

(51) Int. Cl. G09G 5/00

(52) U.S. Cl. 345/2.2

(57) ABSTRACT

In a screen displayed on site in a data format of image data, if a portion of the screen is changed, from among the image data of the entire screen, only an image data subjected to the change is converted to a vector graphics and is transmitted to a remote site via a network. At the remote site, the transmitted vector graphics is reconverted to the image data and is displayed. Further, information necessary for searching an image data is transmitted in association with a vector graphics. This allows a search to be made only from a data which actually requires to be displayed at the remote site.

### CROSS REFERENCE TO RELATED APPLICATIONS

This application claims the benefit of Japanese Patent Application No. 2011-091078 filed on Apr. 15, 2011, the disclosure of which is incorporated herein by reference.

### BACKGROUND OF THE INVENTION

1. Field of the Invention

The present invention relates to a remote monitoring and control system, approach, and program.

2. Description of the Related Art

Electrical power stations are often located by the sea or in the mountains. In many cases, a controller in charge of a plant (for example, a generator or the like) of such an electrical power station monitors and controls the plant at or near that plant (on site). Meanwhile, another controller also monitors the plant in an urban area located away from the plant, such as in an electric power substation, a business office, and a factory of a major user (at a remote site).

A typical example of the monitoring and control of such a plant is as follows. On site, a controller in charge inputs configuration information on a start-stop, an operation speed adjustment or the like of the plant, on a screen using a human-machine interface, and then checks if the configuration information according to the inputted change is displayed on the screen. At a remote site, another controller views a screen similar to the screen on site (see Japanese Laid-Open Patent Application, Publication No. 2002-91557 (paragraph 0006) (to be hereinafter referred to as Patent Document 1); and Japanese Laid-Open Patent Application, Publication No. 2004-227215 (paragraph 0027) (to be hereinafter referred to as Patent Document 2)).

In techniques disclosed in Patent Documents 1 and 2, a screen on site is created in a format of image data. Each time a portion of data on the screen is changed, the image data on the entire screen containing that on the changed part is transmitted to a remote site. The format of the image data is then converted to HTML or XML, which is suitable for general wide-area communications such as the Internet. The converted image data is transmitted to the remote site via the Internet or the like and is displayed at the remote site.

In the techniques disclosed in Patent Documents 1 and 2, an image data on all portions of a screen displayed on site is transmitted to a remote site. The transmitted image data is a set of data in which information for identifying a location of a pixel is associated with pixel information such as intensity. Thus, even if only a slight change is made on the screen on site, a long time is required for communications and regeneration of the screen until the change is viewable at the remote site.

In another example in which a plant is operated around the clock and configuration information of the plant is periodically changed at short intervals, a volume of information on the image data to be transmitted to the remote site is enormous. Moreover, if other information on, for example, a plant in operation and an operator in charge of the operation is also transmitted in association with the image data, the information volume is further increased and more time is required for communications and screen regeneration.

If the image data is subjected to compression and decompression, the time required for communications and screen regeneration can be reduced to some extent. It is difficult, however, to make the communications faster at a speed closer to real-time.

The present invention has been made in an attempt to reduce a time required for communications and regeneration of a data on site which is in a data format of an image data, is subjected to a change, is then transmitted to a remote site, and is regenerated at the remote site.

### SUMMARY OF THE INVENTION

In the present invention, only an image data of a portion subjected to a change of a screen displayed on site is converted to a vector graphics and is transmitted to a remote site via a network. At the remote site, the transmitted vector graphics is reconverted to the image data and is displayed. Further, in the present invention, information necessary for searching an image data is transmitted in association with a corresponding vector graphics. In searching a data, this allows a search to be made only from a data which actually requires to be displayed at the remote site.

Other means for solving the aforementioned problems will be described in detail in an embodiment for carrying out this invention.

In the present invention, in transmitting an image data subjected to a change and regenerating the image data to a remote site, a time required for communications and regeneration of the image data can be reduced.

### BRIEF DESCRIPTION OF THE DRAWINGS

FIG. 1 is a configuration diagram illustrating a remote monitoring and control system according to an embodiment of the present invention.

FIG. 2A is an explanatory diagram illustrating an image data according to the embodiment.

FIG. 2B is an explanatory diagram illustrating a vector graphics according to the embodiment.

FIG. 3A is an explanatory diagram illustrating the image data before change according to the embodiment.

FIG. 3B is an explanatory diagram illustrating the image data after change according to the embodiment.

FIG. 3C is an explanatory diagram illustrating a difference between the image data before and after change according to the embodiment.

FIG. 4 is a diagram illustrating an example of an operation screen for monitoring and control system according to the embodiment.

FIG. 5 is a diagram illustrating an example of a screen for remote computer terminal according to the embodiment.

FIG. 6 is a diagram illustrating an example of difference pixels having a data format of the vector graphics according to the embodiment.

FIG. 7 is a flowchart illustrating steps of a vector graphics transmit processing according to the embodiment.

FIG. 8 is a flowchart illustrating steps of a screen for remote computer terminal switching processing according to the embodiment.

FIG. 9 is a diagram illustrating another example of an operation screen for monitoring and control system according to the embodiment.

### DETAILED DESCRIPTION OF THE EXEMPLARY EMBODIMENT

An embodiment for carrying out the present invention (to be hereinafter referred to as “this embodiment”) is described below in detail with reference to related drawings. In this embodiment, description is made assuming that a plant (for example, a generator or the like) of an electrical power station is monitored and controlled. This embodiment is, however, illustrated only as an example. The present invention is generally applicable to a case in which an image data representing an operation state of an instrument is monitored.

### <Remote Monitoring and Control System>

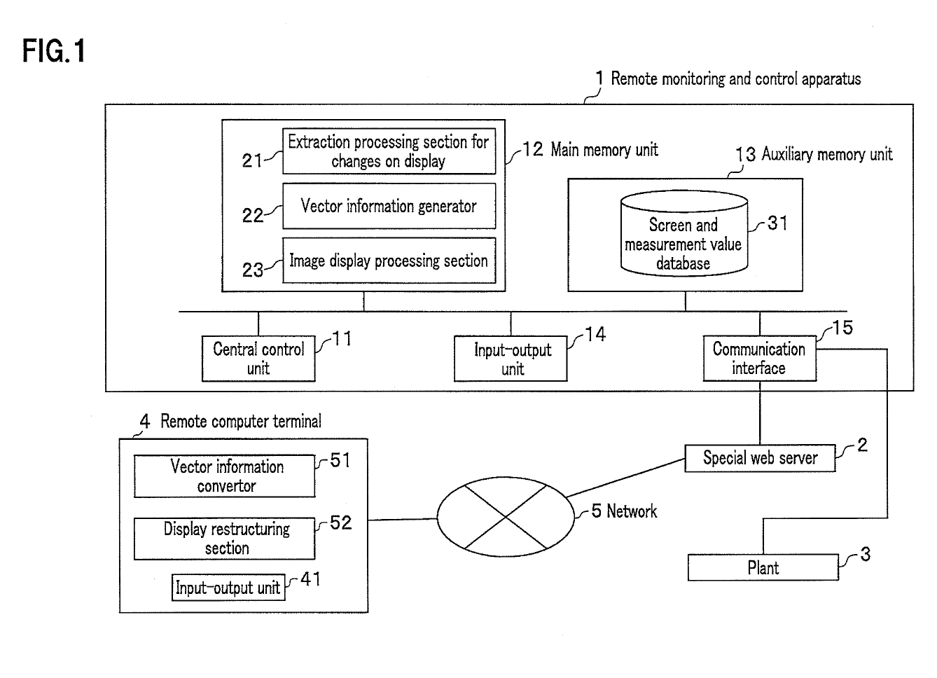

In FIG. 1, a remote monitoring and control system includes: a remote monitoring and control apparatus 1; a special web server 2; and a remote computer terminal 4, and monitors and controls a plant 3. The remote monitoring and control apparatus 1 is directly connected to the special web server 2 and the plant 3. The special web server 2 and the remote computer terminal 4 are connected to each other via a network 5.

The remote monitoring and control apparatus 1, the special web server 2, and the plant 3 are normally installed in a place suitable for locating large-scale facilities such as an electrical power station. The remote computer terminal 4 is normally established in a place where service can be easily provided to end users such as consumers of power.

The remote monitoring and control apparatus 1 and the remote computer terminal 4 may also be referred to as a “server” and a “computer terminal”, respectively.

### <Remote Monitoring and Control Apparatus>

The remote monitoring and control apparatus 1 is a commonly-used computer and includes a central control unit 11, a main memory unit 12, an auxiliary memory unit 13, an input-output unit 14, and a communication interface (IF) 15. Those components are interconnected via a bus. The auxiliary memory unit 13 includes a screen and measurement value database 31 (to be described in detail hereinafter). Each of an extraction processing section for changes on display 21, a vector information generator 22, and an image display processing section 23 in the main memory unit 12 is a program. To simplify description, those components 21 to 23 are herein assumed to directly perform their respective functions (to be described in detail hereinafter). It is, however, the central control unit 11 that actually reads and loads the each program from the auxiliary memory unit 13 into the main memory unit 12 and performs each function of the program.

### <Remote Computer Terminal>

The remote computer terminal 4 is also a commonly-used computer and includes: a central control unit; a main memory unit; an auxiliary memory unit; an input-output unit 41; and a communication interface (IF) (all but the input-output unit 41 not shown), which are interconnected via a bus. The remote computer terminal 4 also includes a vector information convertor 51 and a display restructuring section 52, each of which is a program. To simplify description, those components 51, 52 are herein assumed to directly perform their respective functions (to be described in detail hereinafter). It is, however, the central control unit that actually reads and loads the each program from the auxiliary memory unit into the main memory unit, and performs a function of the program.

### <Plant>

The plant 3 is commonly-used equipment such as, for example, a generator and a valve. The plant 3 has, for example, a microcomputer and a sensor (both not shown). The sensor measures a value representing an operation state of a mechanical part of a plant (for example, a valve opening and a rotation speed). The microcomputer acquires a measurement value from the sensor, converts the value into electronic data, makes the data associated with information for identifying the plant 3, and transmits the data to the remote monitoring and control apparatus 1.

### <Special Web Server>

The special web server 2 is also a commonly-used computer and includes a central control unit, a main memory unit, an auxiliary memory unit, an input-output unit, and a communication interface (IF), which are interconnected via a bus (all not shown).

Above is described an example in which the remote monitoring and control apparatus 1 is configured to include the extraction processing section for changes on display 21 and the vector information generator 22. However, the special web server 2 may be configured to include the extraction processing section for changes on display 21 and the vector information generator 22. This configuration makes it possible to reduce a processing load of the remote monitoring and control apparatus 1. In the following explanation, however, the former example is described in which the remote monitoring and control apparatus 1 includes the extraction processing section for changes on display 21 and the vector information generator 22.

### <Image Data and Vector Graphics>

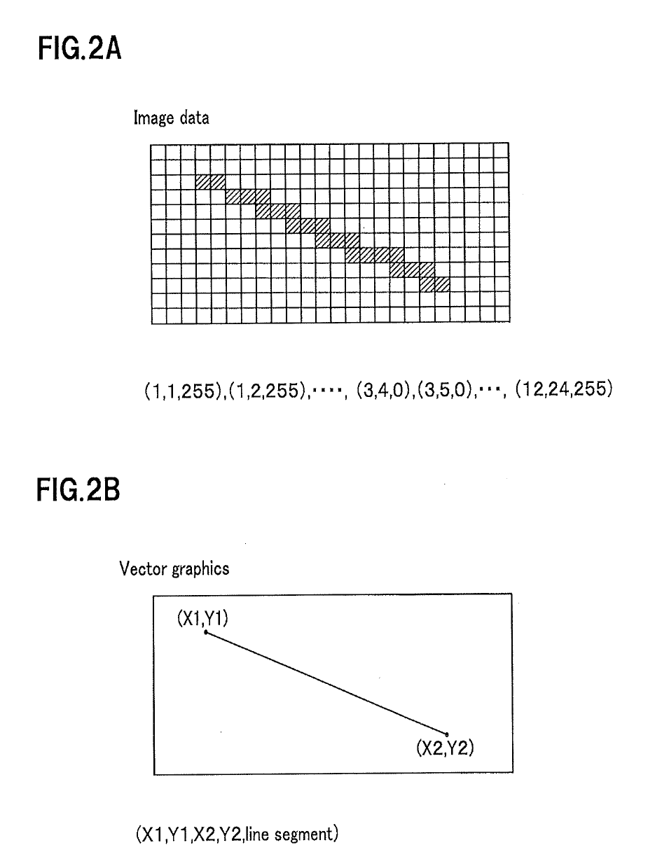

Next is described a difference between an image data and a vector graphics with reference to FIG. 2A and FIG. 2B.

A typical screen of an output unit for a computer is made up of a number of pixels regularly aligned in a grid. If the screen is black-and-white, for example, each of the pixels has a pixel value representing intensity thereof. FIG. 2A is an explanatory diagram illustrating an image data on an enlarged screen on which square-shaped pixels are aligned on a 12×24 grid. Let a pixel value of a pixel located in a portion representing a line segment (the hatched pixel) be “0”. Let a pixel value of a pixel located in the other portion be “255”. In order to display the line segment on a screen as shown in FIG. 2A, data of “(1,1,255),(1,2,255), . . . , (3,4,0), (3,5,0), . . . , (12,24,255)” are required. Herein, each “( )” represents a pixel. “p1” of (p1,p2,p3) represents an ordinate value of the pixel (“0” at the top end); “p2” represents an abscissa thereof (“0” at the left end); and “p3” represents a value thereof.

A data format described above is referred to as an image data. The image data is a data format for displaying an image in a broad sense including not only a graphic but also a character and the like. However, if a data in the data format of the image data is used not for display but for storage or transmission, an information volume of the data is enormous and is sometimes redundant. It is to be understood that even if a pixel remains unchanged over time or corresponds to a blank margin, the pixel always has its coordinate value and pixel value. This means that a number of pixels which are of less importance should also be stored or transmitted.

In the meantime, as shown in FIG. 2B, a line segment can be uniquely determined, if definition is made on “coordinates of two end points” and “that the two end points are connected by a straight line”. The definition is sufficiently made only with data of “(X1,Y1,X2,Y2,line segment)”. A data format as described above is called a vector graphics. The vector graphics is suitable for storage or transmission of data. The vector graphics and the image data are convertible to each other by using a well-known technique. Note that the image data is also called a raster data. In this embodiment, however, the term “image data” is used.

In this embodiment, the image data means a set of combinations of a location of each pixel and a value of the each pixel on an entire screen. Each pixel contained in the set does not include any data on whether or not the pixel is information meaningful to a user. In contrast, the vector graphics can be described as information which shows where and how a data which a user has determined to be meaningful is present on a screen.

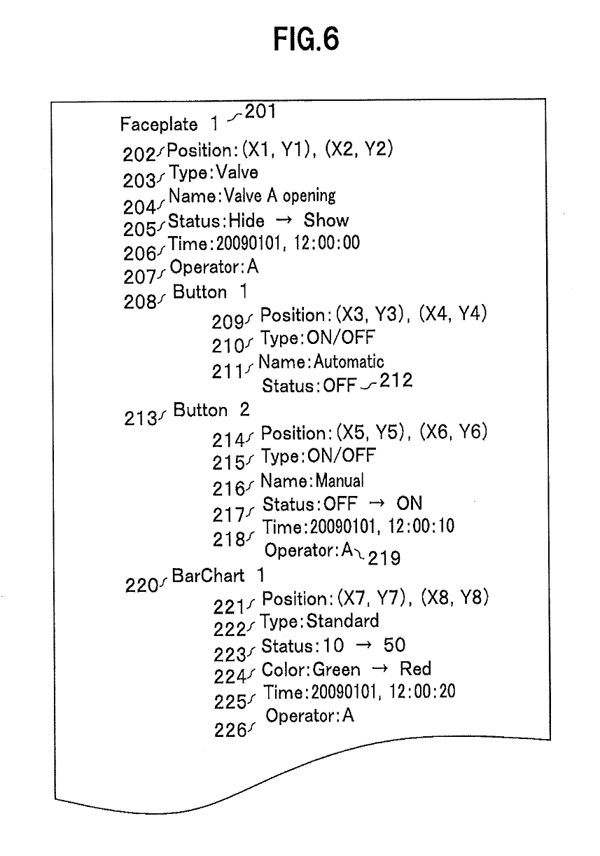

The vector graphics is represented with a character or a numeral (in text format). For ease of explanation, a simple vector graphics “(X1,Y1,X2,Y2,line segment)” is given as an example in FIG. 2B. The vector graphics in this embodiment actually has a more complicated and detailed configuration than that of the example (to be described hereinafter with reference to FIG. 6). Yet, the vector graphics in this embodiment can still reduce a time required for communications and screen regeneration, details of which is described hereinafter.

### <Extraction of Changed Portion>

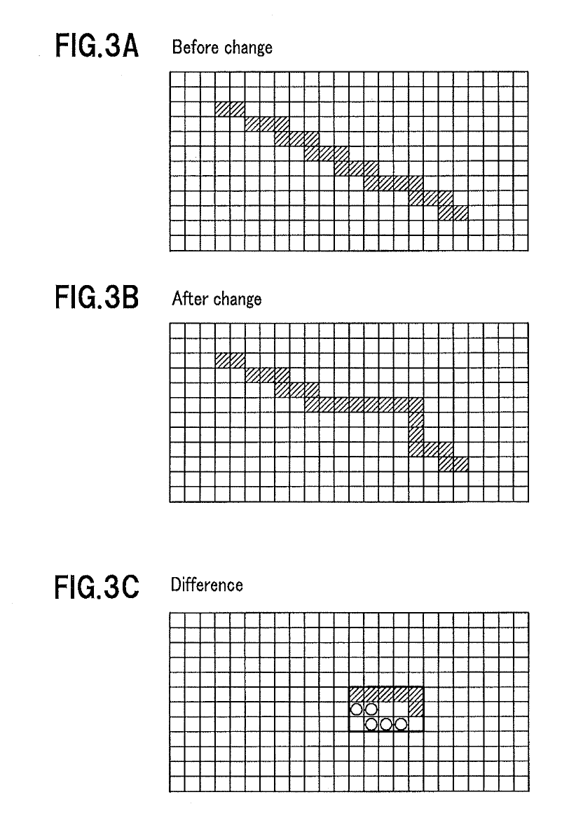

In this embodiment, in an image data representing an entire screen, only an image data of a portion subjected to a change is extracted; is converted into a vector graphics; and is transmitted via a network. For example, let us assume a case in which an image data representing a line segment which has been previously straight is currently changed to an image data representing the line segment which is currently a polyline. FIG. 3A is an explanatory diagram illustrating the image data before the change. FIG. 3B is an explanatory diagram illustrating the image data after the change.

At a first time point, the input-output unit 14 of the remote monitoring and control apparatus 1 displays the image data of FIG. 3A. Let us assume that the input-output unit 41 of the remote computer terminal 4 also displays an identical image data.

At a second time point which is later than the first time point, a portion of the image data is changed. The input-output unit 14 of the remote monitoring and control apparatus 1 displays the image data of FIG. 3B. Below is an outline of a processing for displaying the image data after change (FIG. 3B) in the input-output unit 41 of the remote computer terminal 4.

1) The extraction processing section for changes on display 21 compares the image data before change (FIG. 3A) to the image data after change (FIG. 3B) with respect to all pixels thereof and extracts any pixel having different pixel values.

The extracted pixel is shown with hatching or with a white circle “∘” in FIG. 3C. The hatched pixel represents a pixel whose pixel value is updated to “0” after change. The pixel with “∘” represents a pixel whose pixel value is updated to “255” after change.

2) The extraction processing section for changes on display 21 refers the image data of the pixels with hatching or “∘” in FIG. 3C as a “difference pixel”. Alternatively, the difference pixel may be an image data in a shape of any given graphic figure such as, for example, a rectangle in which all pixels with hatching or “∘” are included.

It is to be noted that pixel information on a pixel constituting a difference pixel corresponds to pixel information on an image data after change. In other words, the difference pixel represents an image data of a portion subjected to a change.

3) The vector information generator 22 converts a data format of the difference pixels from the image data (the raster information) to the vector graphics. The vector information generator 22 then transmits the difference pixels in the data format of the vector graphics, to the remote computer terminal 4.

4) The vector information convertor 51 receives the difference pixels in the data format of the vector graphics and reconverts the data format thereof to the image data.

5) The display restructuring section 52 changes, of the pixels of the image data (FIG. 3A) which have already been displayed on the input-output unit 41, pixel information on pixels corresponding to the difference pixels, to pixel information on the difference pixels. The display restructuring section 52 makes no change to pixels other than those corresponding to the difference pixels.

### <Operation Screen for Monitoring and Control System>

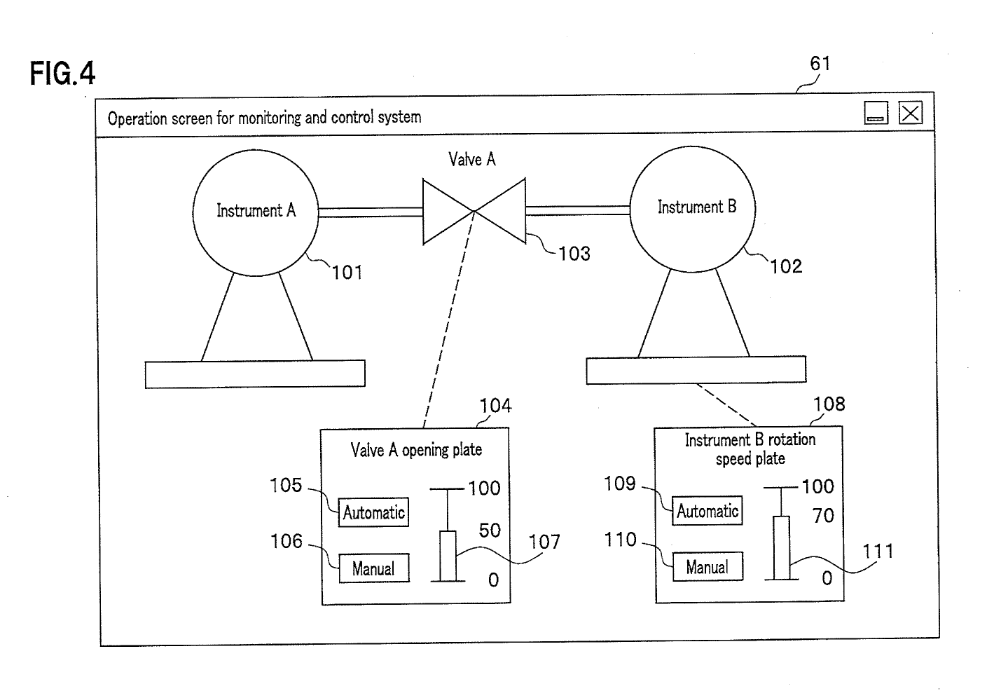

FIG. 4 is a diagram illustrating an example of an operation screen for monitoring and control system 61 which appears in the input-output unit 14 of the remote monitoring and control apparatus 1. The operation screen for monitoring and control system 61 graphically displays, by default, an instrument A 101, an instrument B 102, a valve A 103, and piping connecting therebetween. It is assumed herein that a controller in charge is present near the plant 3 (on site) and wants to change an opening of the valve A 103 from “10” to “50”.

1) The controller selects a graphic (an icon) of the valve A 103 on the operation screen for monitoring and control system 61, with a pointing device (that is, the input-output unit 14) such as a mouse. Or, the controller directly touches the icon with his/her finger.

2) In response, the image display processing section 23 additionally screen-displays a valve A opening plate 104 as an operation window. The valve A opening plate 104 includes an automatic button 105, a manual button 106, and a barchart 107.

3) The controller selects the manual button 106 with the pointing device or directly touches the manual button 106. The controller then drags an upper edge of a bar graph of the barchart 107 with the pointing device and moves the pointing device from a scale mark of “10” to a scale mark of “50”.

The opening of “50” of the valve A 103 having been inputted as described above: is associated with information such as a name of the controller in charge who carries out the operation, a time when the operation is carried out, and an instrument to which the operation is carried out; is stored in the screen and measurement value database 31; and is transmitted to the plant 3, which is the valve A 103 in this case. The microcomputer of the plant 3 changes the opening of the valve A 103 from “10” to “50”.

The valve A opening plate 104 on the operation screen for monitoring and control system 61 disappears upon a prescribed operation by the controller or automatically after an elapse of a prescribed period of time. Then, the controller selects the valve A 103 on the screen 61 with the pointing device or directly touches the valve A 103 with his/her finger. The image display processing section 23 redisplays the valve A opening plate 104 on the operation screen for monitoring and control system 61, based on data stored in the screen and measurement value database 31. That is, at this time, the barchart 107 indicates the scale mark of “50”.

Another case is assumed in which an on-site controller in charge wants to change a rotation speed (rpm) of the instrument B 102 from “40” to “70”.

1) The controller selects a graphic (an icon) of the instrument B 102 on the operation screen for monitoring and control system 61 with a pointing device such as a mouse or directly touches the icon with his/her finger.

2) In response, the image display processing section 23 additionally screen-displays an instrument B rotation speed plate 108 as an operation window. The instrument B rotation speed plate 108 includes an automatic button 109, a manual button 110, and a barchart 111. A subsequent processing is performed similarly to that of the valve A opening plate 104.

### <Difference Pixels>

An initial state of the operation screen for monitoring and control system 61 (FIG. 4) is compared to a state thereof immediately after the operation by the controller. In the initial state, the operation screen for monitoring and control system 61 displays only graphics of the instrument A 101, the instrument B 102, the valve A 103, and the piping connecting therebetween. Meanwhile, in the state immediately after the operation by the controller, the operation screen for monitoring and control system 61 also displays the valve A opening plate 104 in addition to the instrument A 101, the instrument B 102, the valve A 103, and the piping connecting therebetween.

The extraction processing section for changes on display 21: takes the initial state as the image data before change which is described above with reference to FIG. 3A; also takes the state immediately after the operation by the controller, as the image data after change which is described above with reference to FIG. 3B; and extracts a difference between the two states. The image data extracted as the difference is identical to an image data of the valve A opening plate 104 (including the buttons 105, 106 and the barchart 107).

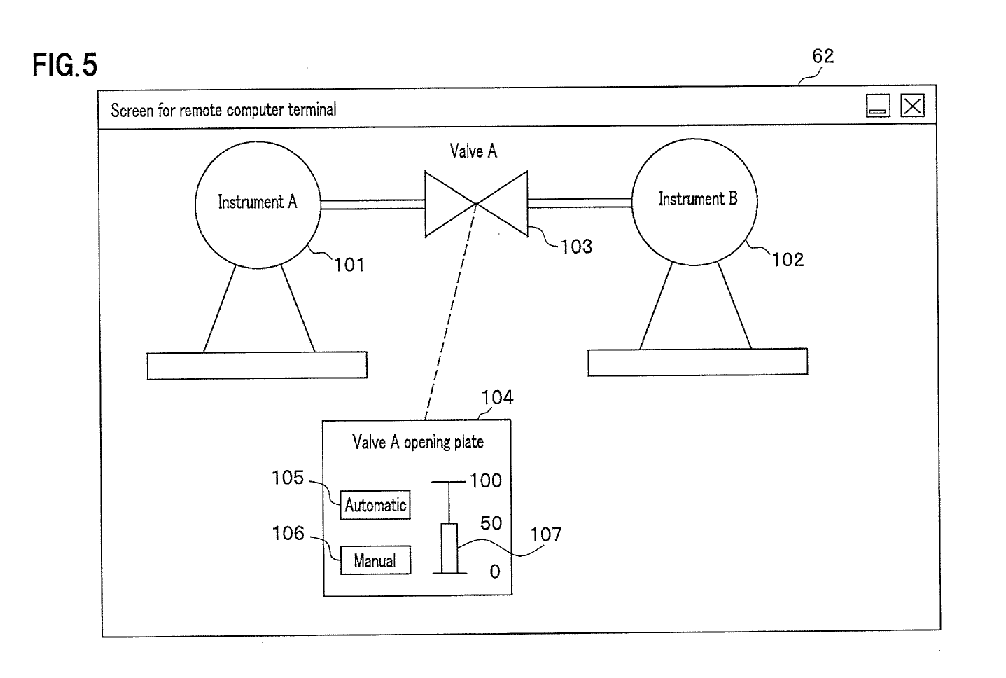

Prior to explanation of FIG. 5, next is described FIG. 6.

FIG. 6 is a diagram illustrating an example of a difference data obtained after the data format is converted from the image data to the vector graphics.

“Faceplate 1” 201 represents that information thereafter is relevant to the valve A opening plate 104.

“Position:(X1,Y1),(X2,Y2)” 202 represents that an upper left point and a lower right point of a rectangle (to be described hereinafter) constituting the valve A opening plate 104 are located at a point (X1,Y1) and a point (X2,Y2), respectively, on the operation screen for monitoring and control system 61.

“Type:Valve” 203 represents that the valve A opening plate 104 is used for operating a valve opening and is rectangular in shape by a definition previously set by the controller.

“Name:Valve A opening” 204 represents that a character string of “Valve A opening” is described on the valve A opening plate 104.

“Status:Hide→Show” 205 represents that the valve A opening plate 104 which has been hidden becomes shown.

“Time:20090101, 12:00:00” 206 represents that the valve A opening plate 104 which has been hidden becomes shown at the year, month, day, hour, minute, and second of “20090101, 12:00:00”.

“Operator:A” 207 represents that it is a controller “A” who has conducted an operation of making the valve A opening plate 104 shown.

“Button 1” 208 represents that information thereafter is relevant to the automatic button 105.

“Position:(X3,Y3),(X4,Y4)” 209 represents that an upper left point and a lower right point of a rectangle (to be described hereinafter) constituting the automatic button 105 are located at a point (X3,Y3) and a point (X4,Y4), respectively, on the operation screen for monitoring and control system 61.

“Type:ON/OFF” 210 represents that a status of the automatic button 105 is selected from “ON” and “OFF” and is rectangular in shape by a definition previously set by the controller.

“Name:Automatic” 211 represents that a character string of “Automatic” is described on the automatic button 105.

“Status:OFF” 212 represents that the status of the automatic button 105 is “OFF”.

“Button 2” 213 represents that information thereafter is relevant to the manual button 106.

“Position:(X5,Y5),(X6,Y6)” 214 represents that an upper left point and a lower right point of a rectangle (to be described hereinafter) constituting the manual button 106 are located at a point (X5,Y5) and a point (X6,Y6), respectively, on the operation screen for monitoring and control system 61.

“Type:ON/OFF” 215 represents that a status of the manual button 106 is selected from “ON” and “OFF” and is rectangular in shape by a definition previously set by the controller.

“Name:Manual” 216 represents that a character string of “Manual” is described on the manual button 106.

“Status:OFF→ON” 217 represents that the status of the manual button 106 is changed from “OFF” to “ON”.

“Time:20090101,12:00:10” 218 represents that the status of the manual button 106 is changed from “OFF” to “ON” at the year, month, day, hour, minute, and second of “20090101,12:00:10”.

“Operator:A” 219 represents that it is the controller “A” who has conducted an operation of changing the status of the manual button 106.

“BarChart 1” 220 represents that information thereafter is relevant to the barchart 107.

“Position:(X7,Y7),(X8,Y8)” 221 represents that an upper left point and a lower right point of a rectangle (to be described hereinafter) constituting the barchart 107 are located at a point (X7,Y7) and a point (X8,Y8), respectively, on the operation screen for monitoring and control system 61.

“Type:Standard” 222 represents that a type of a method of operating the barchart 107 is “Standard” (a standard type without an electrical interlock or the like) and that the barchart 107 is a graphic having a shape of a combined rectangle and scale marks by a definition previously set by the controller.

“Status:10→50” 223 represents that the status of the barchart 107 is changed from the scale mark of “10” to “50”.

“Color:Green→Red” 224 represents that a color of the barchart 107 is changed from “Green” to “Red”.

“Time:20090101,12:00:20” 225 represents that the status of the barchart 107 is changed from the scale mark of “10” to “50” at the year, month, day, hour, minute, and second of “20090101,12:00:20”.

“Operator:A” 226 represents that it is the controller “A” who has conducted an operation of changing the status of the barchart 107.

As described above, information constituting the difference data of FIG. 6 is a “vector graphics” which shows how and where meaningful information is present on a screen.

For example, “Time:20090101,12:00:00” 206, “Operator:A” 207, and the like of the above-described information are not subjected to a conversion based on a difference between the image data before and after change. Rather, such information just indicates a date and time of an operation, a controller of the operation, and the like. Regarding information other than the described above, the vector information generator 22 reads a shape of a graphic or a character from among difference pixels in the data format of the image data. The vector information generator 22 then converts the data format of the read information into text data such as “Type:Valve” 203 and “Name:Valve A opening” 204, using a well-known technique, for example, the template matching. The vector information generator 22 also reads a value of a coordinate at which a graphic is positioned and represents the coordinate value in text data such as “Position:(X1,Y1),(X2,Y2)”.

The information indicating a date and time of an operation and a controller thereof may also be referred to as “additional information”.

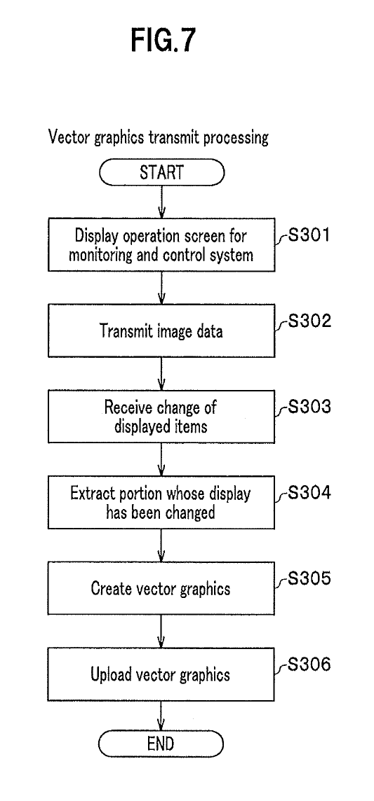

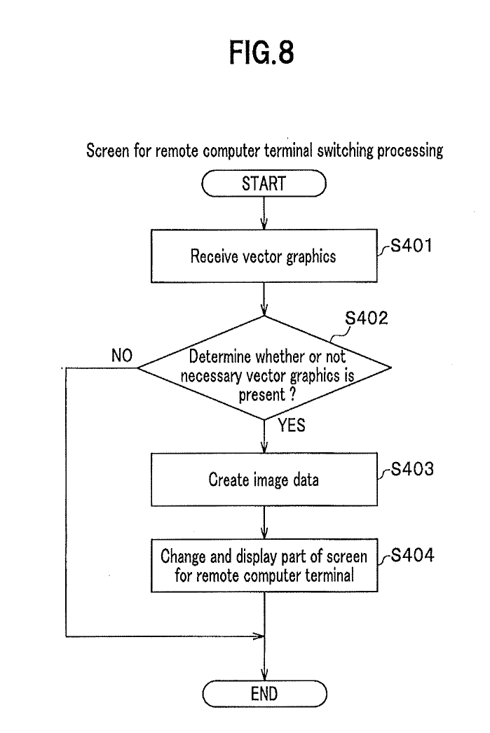

Next are described steps of a vector graphics transmit processing and steps of a screen for remote computer terminal switching processing with reference to FIG. 7 and FIG. 8, respectively. The steps of the vector graphics transmit processing are mainly performed by the remote monitoring and control apparatus 1. The steps of the screen for remote computer terminal switching processing are mainly performed by the remote computer terminal 4. The steps of the screen for remote computer terminal switching processing get started only after the steps of the vector graphics transmit processing are completed.

### <Steps of Vector Graphics Transmit Processing>

Next are described the steps of the vector graphics transmit processing with reference to FIG. 7.

In step S301, the image display processing section 23 of the remote monitoring and control apparatus 1 displays the operation screen for monitoring and control system 61.

More specifically, first, the image display processing section 23 receives an input of a request for displaying the operation screen for monitoring and control system 61 (FIG. 4) from a controller.

Second, the image display processing section 23 acquires information necessary to create the operation screen for monitoring and control system 61, from the screen and measurement value database 31. The screen and measurement value database 31 is assumed to previously store therein data necessary to create the operation screen for monitoring and control system 61 (which may also be referred to as a screen creation data).

Third, the image display processing section 23 displays the operation screen for monitoring and control system 61 in the input-output unit 14 based on the screen creation data. At this stage, the input-output unit 14 displays the operation screen for monitoring and control system 61 as shown in FIG. 4. However, the valve A opening plate 104 and the instrument B rotation speed plate 108 are not yet displayed on the operation screen for monitoring and control system 61. The image display processing section 23 then stores an image data of the operation screen for monitoring and control system 61 at this time point (an image data before change), in the main memory unit 12.

In step S302, the image display processing section 23 of the remote monitoring and control apparatus 1 transmits the image data.

More specifically, the image display processing section 23 transmits the image data before change to the remote computer terminal 4. Then, though not shown in FIG. 7, the display restructuring section 52 of the remote computer terminal 4 displays the screen for remote computer terminal 62 (FIG. 5) in the input-output unit 41, based on the transmitted image data before change. At this stage, the valve A opening plate 104 and the instrument B rotation speed plate 108 are not yet displayed on the screen for remote computer terminal 62. Herein, a data format of the transmitted image data before change is the image data (raster data). The display restructuring section 52 displays FIG. 5 in the data format of the image data, in the input-output unit 41 using a well-known technique.

In step S303, the image display processing section 23 of the remote monitoring and control apparatus 1 receives a change of a displayed item.

More specifically, first, the image display processing section 23 receives an input from a controller, of a name of the controller via the input-output unit 14 (a card reader or the like).

Second, the image display processing section 23 receives an input of a selection of the plant 3. The selection is performed by the controller either by selecting a portion representing the given plant 3 on the operation screen for monitoring and control system 61 with a pointing device or by directly touching the portion. It is assumed herein that the controller touches a portion representing the valve A 103.

Third, the image display processing section 23 displays an operation window corresponding to the selected plant 3. In this case, the valve A opening plate 104 is displayed as the operation window. It is also assumed herein that the remote monitoring and control apparatus 1 previously stores a data required for displaying an appropriate operation window associated with the plant 3, in the auxiliary memory unit 13.

Fourth, the image display processing section 23 receives an input of a configuration value for the plant 3 from the controller. The input is realized by operating a button, a barchart, or the like on an appropriate operation window by the controller. Herein, let the manual button 106 be pressed and the barchart 107 be set at the scale mark of “50”. The image display processing section 23 acquires a current time of the input. Note that the operation window is kept displayed without disappearing until a prescribed sufficient time period elapses after the above-described current time.

Different current times may be acquired each time an event occurs. Such an event includes, for example, a display of the valve A opening plate 104, a press-down of the manual button 106, and a setting of the barchart 107 at the scale mark of “50” (FIG. 6 exemplifies this case).

Fifth, the image display processing section 23 associates the current time acquired in the fourth substep (which may also be referred to as screen change trigger information) and the name of the controller received in the first substep with each other and stores the both of the associated data, in a prescribed area in the main memory unit 12 (which may also be referred to as screen change trigger area).

Sixth, the image display processing section 23 transmits the configuration value received in the fourth substep to the plant 3 selected in the second substep. Upon receipt of the configuration value, the plant 3 changes an operation state. In this example, the configuration value is transmitted to the valve A 103 and the microcomputer of the valve A 103 changes an opening thereof to “50”.

In step S304, the extraction processing section for changes on display 21 of the remote monitoring and control apparatus 1 extracts a portion whose display has been subjected to a change.

More specifically, first, the extraction processing section for changes on display 21 detects the screen change trigger information from the screen change trigger area in the main memory unit 12. It is assumed herein that the extraction processing section for changes on display 21 constantly monitors the screen change trigger area and that step S304 is started when the extraction processing section for changes on display 21 detects the screen change trigger information.

Second, the extraction processing section for changes on display 21 acquires an image data of the operation screen for monitoring and control system 61 which is displayed in the input-output unit 14 at a current point of time (an image data after change).

Third, the extraction processing section for changes on display 21 compares the image data before change stored in the third substep of step S301, with the image data after change and acquires difference pixels therefrom. The extraction processing section for changes on display 21 herein detects whether or not pixel information between each pair of corresponding pixels before and after change is different. Details of this processing are as stated above. After step S304 is successfully completed, an image data of a portion corresponding to the valve A opening plate 104 as an operation window is acquired as difference pixels.

In step S305, the vector information generator 22 of the remote monitoring and control apparatus 1 creates a vector graphics.

More specifically, first, the vector information generator 22 converts the data format of the difference pixels acquired in the third substep of step S304, from the image data to the vector graphics.

Second, the vector information generator 22 adds the current time and the name of the controller stored in the fifth substep of step S303, to immediately after a displayed item subjected to a change, from among the difference pixels of which data format was converted to the vector graphics. For example, in FIG. 6, “→” is contained in “Status:Hide→Show” 205, “Status:OFF→ON” 217, “Status:10→50” 223 and “Color:Green→Red” 224. Thus, “Time:20090101,12:00:00”, “Time:20090101,12:00:10”, and “Time:20090101,12:00:20” are added to positions at the reference numerals 206, 218, and 225, respectively. “Operator:A” is added to each of positions at the reference numerals 207, 219, and 226. The difference pixels at this point of time thus have all of the information as shown in FIG. 6.

In step S306, the vector information generator 22 of the remote monitoring and control apparatus 1 uploads the vector graphics.

More specifically, the vector information generator 22 transmits the difference pixels which are created in step S305 and have the data format of the vector graphics, to the special web server 2. The difference pixels may be subjected to encryption and then transmitted.

At this time, the remote computer terminal 4 can retrieve the difference pixels any time via the network 5. The special web server 2 may transfer the difference pixels to the remote computer terminal 4 immediately after receipt of the difference pixels.

After that, the steps of the vector graphics transmit processing terminate.

### <Steps of Screen for Remote Computer Terminal Switching Processing>

Next are described steps of a screen for remote computer terminal switching processing with reference to FIG. 8.

The description is made on an assumption as follows. At the time when the steps of the screen for remote computer terminal switching processing are started, the screen for remote computer terminal 62 (FIG. 5) which is displayed by the display restructuring section 52 of the remote computer terminal 4 in step S302 of the vector graphics transmit processing, is still displayed in the input-output unit 41. The special web server 2 transfers the difference pixels to the remote computer terminal 4 immediately after the receipt of the difference pixels in step S306 of the vector graphics transmit processing.

In step S401, the display restructuring section 52 of the remote computer terminal 4 receives the vector graphics.

More specifically, the display restructuring section 52 receives the difference pixels whose data format is the vector graphics, from the special web server 2. If the received difference pixels are encrypted, the difference pixels are decrypted.

In step S402, the display restructuring section 52 of the remote computer terminal 4 determines whether or not a necessary vector graphics is present.

More specifically, first, the display restructuring section 52 receives an input of a search key from a remotely-located controller via the input-output unit 41 (a keyboard or the like). It is assumed herein that information on the opening of the valve A 103 is more important for the controller than information on the plant 3 other than the valve A 103. The controller is thus assumed to input “valve A opening” as a search key.

Alternatively, the display restructuring section 52 may acquire a search key which is previously set by the controller and stored in the auxiliary memory unit 13, instead of waiting for an input of a search key from the controller.

Second, the display restructuring section 52 searches the received difference pixels using the “valve A opening” as a search key. If the “valve A opening” is present in the difference pixels (if “YES” in step S402), the processing advances to step S403. And if not (if “NO” in step S402), the display restructuring section 52 displays a character string showing that “there is no particularly-important change” in the input-output unit 41 and terminates the steps of the screen for remote computer terminal switching processing.

Herein, the processing advances to step S403 because the search key of the “valve A opening” (by the reference numeral 204) is assumed to be present in the difference pixels (FIG. 6).

In step S403, the vector information convertor 51 of the remote computer terminal 4 creates an image data.

More specifically, the vector information convertor 51 converts the data format of the difference pixels received in step S401, from the vector graphics to the image data. The converted image data is made up of a combination of a location and a value of a pixel, for each pixel present within an area of a rectangle which has a point (X1,Y1) as an upper left point and a point (X2,Y2) as a lower right point.

In step S404, the display restructuring section 52 of the remote computer terminal 4 changes an appropriate portion of the screen for remote computer terminal 62 and displays the screen 62 reflecting the changed portion.

More specifically, the display restructuring section 52 displays the image data after change in the input-output unit 41. The input-output unit 41 has already displayed the screen for remote computer terminal 62 (FIG. 5). On the screen for remote computer terminal 62, only an image within the area of the rectangle which has the point (X1,Y1) as the upper left point and the point (X2,Y2) as the lower right point is replaced. As a result, the valve A opening plate 104 is newly displayed.

The data added in step S305 such as “Time:20090101,12:00:00” and “Operator:A” may be displayed in an arbitrary position on the screen for remote computer terminal 62 (for example, in a balloon displayed near a graphic representing the appropriate plant 3), may be hidden, or may be displayed upon receipt of a prescribed operation by a controller.

The steps of the screen for remote computer terminal switching processing then terminate.

### <Variation 1>

In step S401, upon receipt of the vector graphics, the display restructuring section 52 of the remote computer terminal 4 may store the vector graphics in an auxiliary memory unit (not shown). This allows the auxiliary memory unit to accumulate a plurality of difference pixels having been transmitted.

In step S402, the search key received by the display restructuring section 52 of the remote computer terminal 4 is not limited to the information for identifying the plant 3 such as the “valve A opening”. The search key may be any text data which can be used as a search key in the difference pixels shown in FIG. 6.

In the second substep of step S402, if the display restructuring section 52 of the remote computer terminal 4 searches a difference pixel and detects a plurality of appropriate difference pixels, then, in step S403, the vector information convertor 51 of the remote computer terminal 4 may create an image data for each of the plural appropriate difference pixels. In step S404, the display restructuring section 52 of the remote computer terminal 4 may display one of the plural image data which has the earliest year, month, day, hour, minute, and second stored as “Time” and also display a message saying “continued to the next page” at or around the displayed image data. The next image data may be displayed one by one in time series according to each instruction from a controller.

For example, a case is assumed in which a failure occurs in the valve A 103 on a given site because the valve A 103 was opened to a risk level, and it is necessary for a remotely-located controller to know which on-site controller changed the opening. If the “valve A opening” and the “Color:Green→Red” are used as search keys, for example, the difference pixels shown in FIG. 6 are obtained and the “Operator:A” 226 shows that the controller is “A”. In another example, if the “valve A opening”, “Operator:A”, and “Time: from 20090101 to 20090131” are used as search keys, all of the operations of the valve A 103 performed by the controller A during January 2009 are detected in time series.

### <Variation 2>

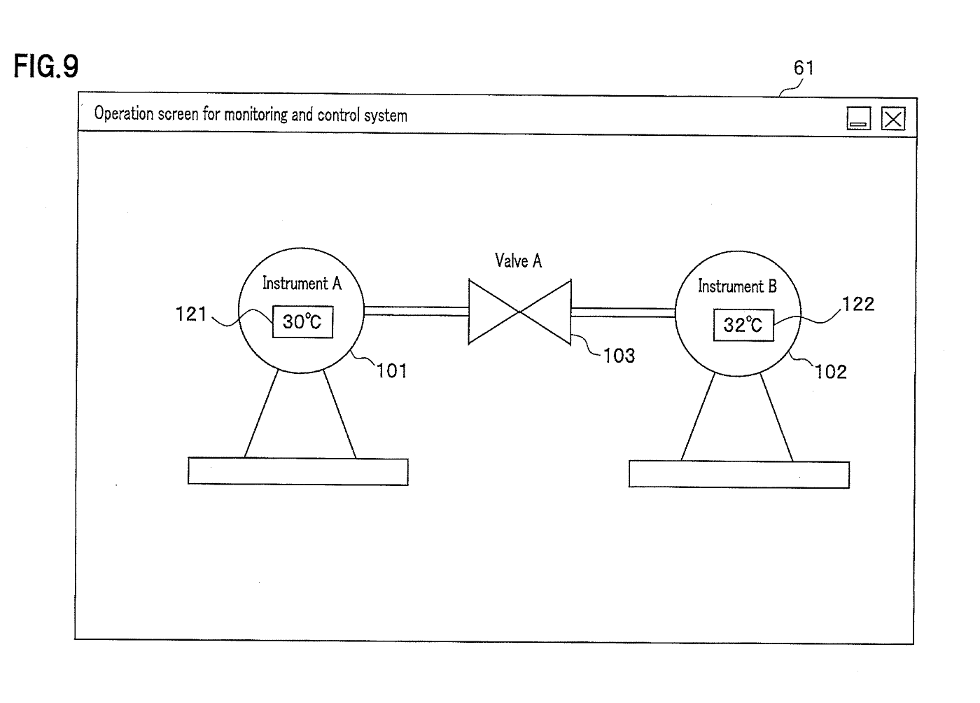

In the aforementioned example, an on-site controller himself/herself operates an operation window, and a portion of the operation screen for monitoring and control system 61 is thereby changed. However, the present invention is also applicable to a case in which a portion of the operation screen for monitoring and control system 61 is automatically changed without an operation by a controller. For example, if a temperature or the like of the plant 3, which is always changing depending on surrounding environment is required to be monitored, the microcomputer of the plant 3 may periodically transmit information on the temperature to the remote monitoring and control apparatus 1. Further, each time the remote monitoring and control apparatus 1 receives information as described above, the remote monitoring and control apparatus 1 may display the received information near an on-screen graphic of the corresponding plant 3 on the operation screen for monitoring and control system 61. The operation screen for monitoring and control system 61 according to this case (FIG. 9) includes temperature display windows 121, 122.

In this case, in step S303, the image display processing section 23 may acquire a current time (which may also be referred to as screen change trigger information) each time the image display processing section 23 receives the information on the temperature and may store the current time in a prescribed area (which may also be referred to as a screen change trigger area) in the main memory unit 12. With this configuration, the extraction processing section for changes on display 21 can acquire information on a temperature, for example, “30° C.” after change, as a difference pixel. Thus, a state of a periodically-changing temperature is visible on the screen for remote computer terminal 62 displayed in the input-output unit 41 of the remote computer terminal 4.

### ADVANTAGEOUS EFFECTS OF EMBODIMENT

According to this embodiment, in a case where an image data subjected to a change on site is transmitted to a remote site and is regenerated at the remote site, a time required for communications and regeneration of the image data can be reduced. This allows a volume of data transmitted in a network to be reduced, which is also advantageous in terms of security. Further, this embodiment eliminates a need to use a complex algorithm such as a conventional compression and decompression technique.

The present invention is not limited to the above-described embodiment and can be modified without departing from the gist of the present invention.

1. A remote monitoring and control system, comprising:
a server that creates a screen in a data format of an image data, and, if a portion of the screen is changed, changes an image data of the portion of the screen; and
a computer terminal that displays a screen thereof exactly the same as the screen displayed by the server,
wherein the server comprises a control part that:
acquires a difference pixel which is a difference of the image data of the screen before and after the change;
converts the data format of the acquired difference pixel into a vector graphics; and
transmits the converted difference pixel to the computer terminal.

2. The remote monitoring and control system according to claim 1,
wherein the computer terminal comprises a control part that:
receives an input of arbitrary information which constitutes the difference pixel or additional information which is added to the difference pixel, via an input device of the computer terminal itself; and
searches an appropriate difference pixel from among the transmitted difference pixel, using the received information as a search key.

3. The remote monitoring and control system according to claim 2,
wherein the additional information used as the search key contains at least one of information showing a date and time when the change is made, and information showing an instrument relevant to the change.

4. A remote monitoring and control method using a remote monitoring and control system, the remote monitoring and control system comprising: a server that creates a screen in a data format of an image data, and, if a portion of the screen is changed, changes an image data of the portion of the screen; and a computer terminal that displays a screen thereof exactly the same as the screen displayed by the server, the remote monitoring and control method comprising the steps, performed by a control part of the server, of:
acquiring a difference pixel which is a difference of the image data of the screen before and after the change;
converting the data format of the acquired difference pixel into a vector graphics; and
transmitting the converted difference pixel to the computer terminal.

5. The remote monitoring and control method according to claim 4, further comprising the steps, performed by a control part of the computer terminal, of:
receiving an input of arbitrary information which constitutes the difference pixel or additional information which is added to the difference pixel, via an input device of the computer terminal itself; and
searching an appropriate difference pixel from among the transmitted difference pixel, using the received information as a search key.

6. The remote monitoring and control method according to claim 5,
wherein the additional information used as the search key contains at least one of information showing a date and time when the change is made, and information showing an instrument relevant to the change.

7. A computer readable medium encoded with a remote monitoring and control program for causing a computer to perform functions of a remote monitoring and control system, the remote monitoring and control system comprising: a server that creates a screen in a data format of an image data, and, if a portion of the screen is changed, changes an image data of the portion of the screen; and a computer terminal that displays a screen thereof exactly the same as the screen displayed by the server, the remote monitoring and control program causing a control part of the server to:
acquire a difference pixel which is a difference of the image data of the screen before and after the change;
convert the data format of the acquired difference pixel into a vector graphics; and
transmit the converted difference pixel to the computer terminal.

8. The computer readable medium according to claim 7,
wherein the remote monitoring and control program further causes a control part of the computer terminal to:
receive an input of arbitrary information which constitutes the difference pixel or additional information which is added to the difference pixel, via an input device of the computer terminal itself; and
search an appropriate difference pixel from among the transmitted difference pixel, using the received information as a search key.

9. The remote monitoring and control program according to claim 8,
wherein the additional information used as the search key contains at least one of information showing a date and time when the change is made, and information showing an instrument relevant to the change.
